(19) United States
(12) Patent Application Publication
(10) Pub. No.: US 2006/0188862 A1
(43) Pub. Date: Aug. 24, 2006

(54) Electronic assessment summary and remedial action plan creation system and associated methods

(75) Inventor: Diane F. Johnson, San Antonio, TX (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(73) Assignee: Harcourt Assessment, Inc., San Antonio, TX (US)

(21) Appl. No.: 11/060,822

(22) Filed: Feb. 18, 2005

(51) Int. Cl. G09B 3/00

(52) U.S. Cl. 434/350; 434/322; 434/362

(57) ABSTRACT

Score results are received from an assessment recorded by a plurality of students in a unitary class. The assessment includes a items that are representative of a plurality of content standards, with each item designed to assess at least one content standard. An electronic correlation is made of incorrect answers for each student with respective content standards. A remedial learning action for each correlated content standard is retrieved, and a remedial learning action plan is automatically produced therefrom. An electronic correlation is also made of incorrect answers for the plurality of students with respective content standards. A proportion of the plurality of students needing remediation is calculated in each of the respective content standards, and a remedial teaching action for each of the content standards for which the calculated proportion exceeds a predetermined value is retrieved. From the retrieved remedial teaching actions is automatically produced a remedial teaching action plan.

### BACKGROUND OF THE INVENTION

1. Field of the Invention

The present invention relates to systems and methods for assessing student knowledge, and, more particularly, to such systems and methods for using assessments to precisely identify and remediate learning deficiencies of a selected class and/or individual within the class.

2. Description of Related Art

Instruments created to examine a student's knowledge of a particular discipline typically include a series of questions to be answered or problems to be solved. Tests have evolved from individually authored, unitarily presented documents into standardized, multiauthor documents delivered over wide geographic ranges and on which multivariate statistics can be amassed. As the importance of test results has increased, for myriad educational and political reasons, so has the field of test creation experienced a concomitant drive towards more sophisticated scientific platforms, necessitating increased levels of automation in every element of the process.

With the “No Child Left Behind” initiative, school districts are increasingly focusing on individual students' performance on a specific subset of content standards measure on an accountability test. The consequences are high if adequate yearly progress is not demonstrated. However, adequate yearly progress is defined on total test performance, not performance on individual content standards.

When standardized tests are given over a large geographic area, for example, statewide, the results are used to rate individual schools against a predetermined standard. After such assessments are scored, grades for each student are provided to the school and to the parents, typically divided into subject areas (e.g., reading, mathematics), and also subdivided into topic areas (e.g., vocabulary, reading comprehension). However, no correlation is made as to specific topic areas that need addressing, nor recommendations on how to remediate these topic areas.

### SUMMARY OF THE INVENTION

The present invention addresses a method for automatically producing a remedial action plan for a plurality of students and for a teacher of the plurality of students. The remedial action plan is based upon assessment results for at least some of the students. Typically the assessment comprises a plurality of items that are representative of a plurality of content standards. Preferably each item is designed to assess at least one content standard.

At least some of the items are answered on an electronically scorable answer sheet or directly into an electronic input device. Either of these devices for recording answers will be referred to in the following as an “answer document,” and no limitation is to be inferred thereby. In either case, the result of the electronic scoring comprises an electronic answer record comprising student answer data, student demographic information, and student class and school information, including teacher identifier.

A particular embodiment of the method comprises the step of receiving score results from answer documents that had been recorded by a plurality of students in a unitary class for the assessment. An electronic correlation is made of incorrect answers for each student with respective content standards. A remedial learning action for each correlated content standard is retrieved from a database, and a remedial learning action plan is automatically produced from the retrieved remedial learning actions.

An electronic correlation is also made of incorrect answers for the plurality of students with respective content standards. A proportion of the plurality of students needing remediation is calculated in each of the respective content standards, and a remedial teaching action for each of the content standards for which the calculated proportion exceeds a predetermined value is retrieved from the database. From the retrieved remedial teaching actions is automatically produced a remedial teaching action plan.

The results of the assessment can be processed, stored, and displayed in many ways. For example, summary reports and individual student reports may be prepared from the correlations. Such reports may be accessible via a processor on site or remotely via the Internet, for example, or may be printed out and distributed to appropriate parties.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is an overview flowchart of an exemplary embodiment of the method of the present invention.

FIG. 2 is a more detailed flowchart of the method of FIG. 1.

FIG. 3 is a system diagram for carrying out the method of FIG. 2.

FIG. 4 is an exemplary summary ranking report.

FIG. 5 is an exemplary student detail report.

FIG. 6 is an exemplary student score report.

FIG. 7 is an exemplary table of items grouped into subdivisions and their respective performance indicators.

FIG. 8 is an exemplary table correlating performance indicators with remedial action plans.

FIG. 9 is another exemplary table similar to that in FIG. 7 correlating performance indicators with remedial action plans.

### DETAILED DESCRIPTION OF THE PREFERRED EMBODIMENTS

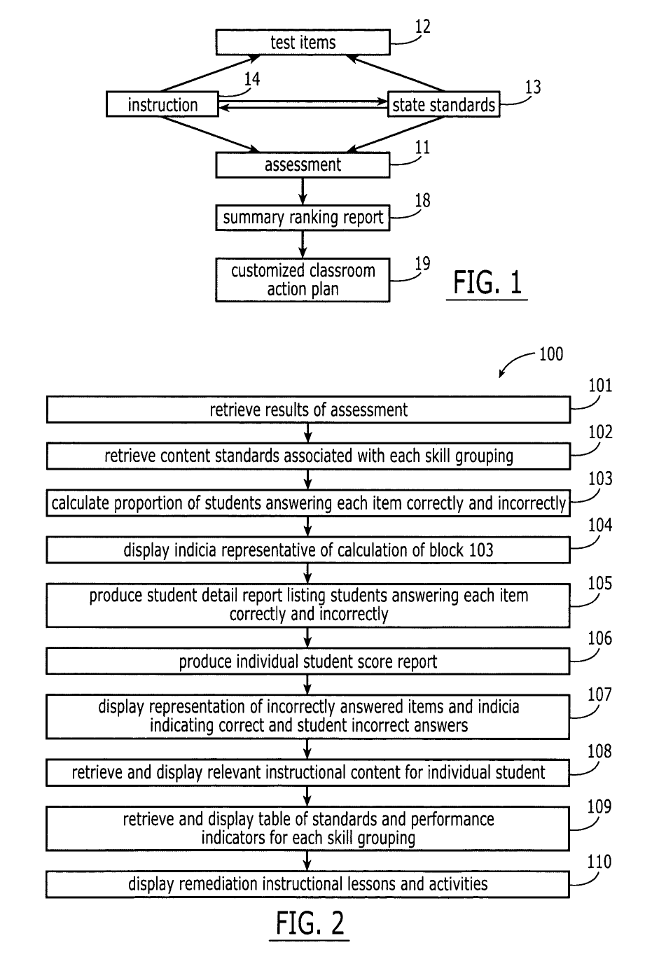

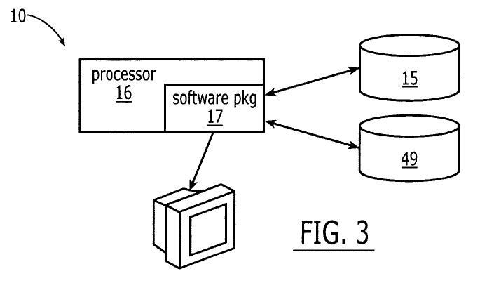

A description of the preferred embodiments of the present invention will now be presented with reference to FIGS. 1-9.

The present invention addresses a system 10 and method 100 (FIGS. 1-3) for automatically producing a remedial action plan for a plurality of students and for a teacher of the plurality of students. The system 10 and method 100 provide item-specific data on individual students and on a group of students, such as a class. An assessment 11 comprising a plurality of test items 12 has been created to test students' achievement commensurate with standards, for example, state standards 13, which will have been taught by way of specific instruction 14.

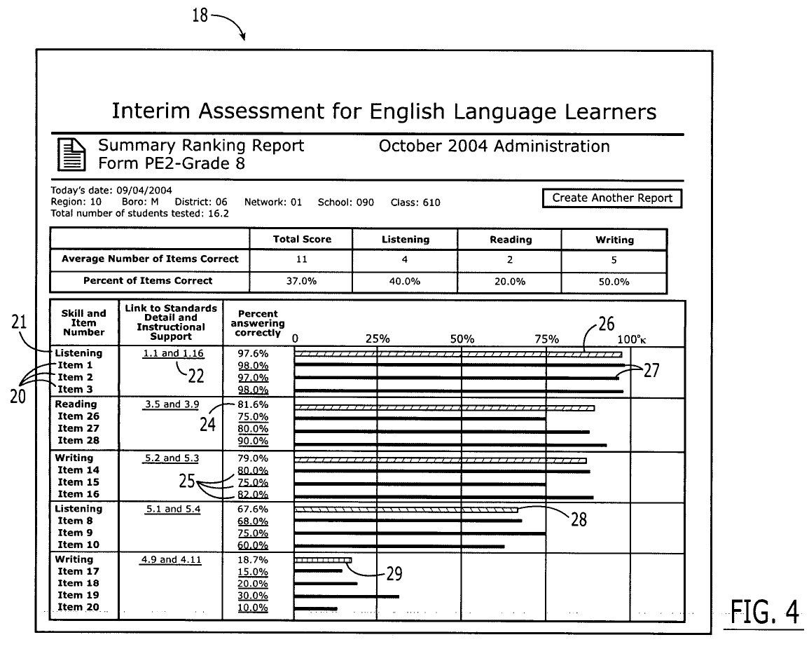

As stated above, an electronic answer record comprising student answer data, including identifiers for correctly and incorrectly answered items, student demographic information, and student class and school information, including teacher identifier, are supplied and stored in a form, such a first database sector 15, that is accessible by a processor 16. The processor 16 is capable of running a software package 17 that contains code segments for performing at least some of the method steps, including retrieving score results (block 101, FIG. 2) from the first database sector 15 and generating reports such as those exemplified in FIGS. 4-9. Among the generated reports are included a summary ranking report 18 (FIG. 4) and a customized classroom action plan 19.

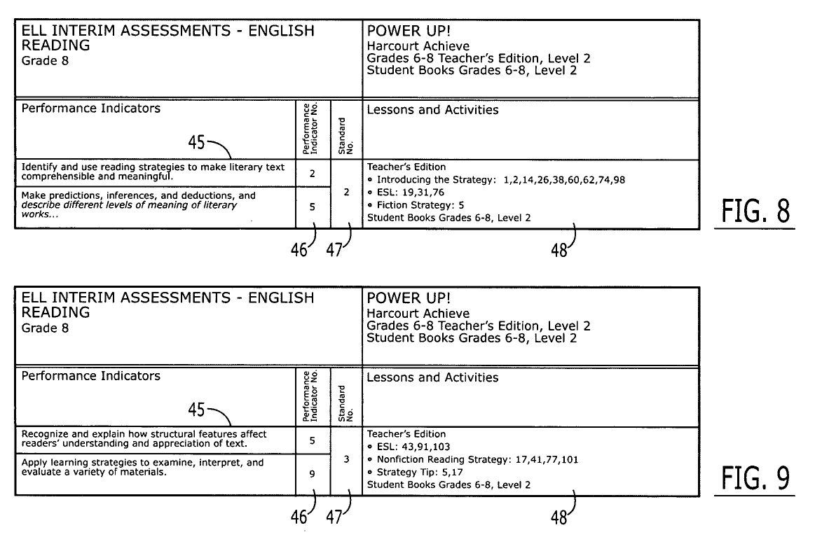

The summary ranking report 18 of FIG. 4, in exemplary form for displaying results of a language assessment, contains a wealth of information, including a numerical and graphical display of the language skill assessed and item number, along with related standards indicia and performance indicators. In this exemplary report, the first column comprises the item numbers 20 separated into skill groupings 21, such as “listening” and “reading.” The second column lists indicia 22 representative of the content standard(s) associated with each skill grouping 21 (block 102). These indicia 22 also comprise electronic links to details on the respective content standard(s) and instructional support therefor, such as illustrated in FIGS. 8 and 9.

The third column on the summary ranking report 18 contains indicia for each item representative of the proportion (percentage here) 23 of the plurality of students who answered the respective item correctly (block 103). The first row value 24 is the average for the skill grouping 21; the following rows within the skill grouping 21 include item values 25 are for the individual items. The skill groupings 21 are presented in descending order of performance, although this is not intended as a limitation.

The average value 24 and the item values 25 are also presented graphically on the right-hand side of the summary ranking report 18. The graphical representations are in the form of a horizontal bar 26 for the average value 24 and another horizontal bar 27 for the item values 25. Although not depictable on FIG. 4, in an exemplary embodiment, the average value bars 26 are also color coded to alert the viewer of problem areas. For example, a green bar 26 would represent an acceptable average score for the class, such as above 75%; a yellow bar 28 would signal a potential problem, such as between 50 and 75%; a red bar 29 would signal a definite problem, such as below 50% (block 104).

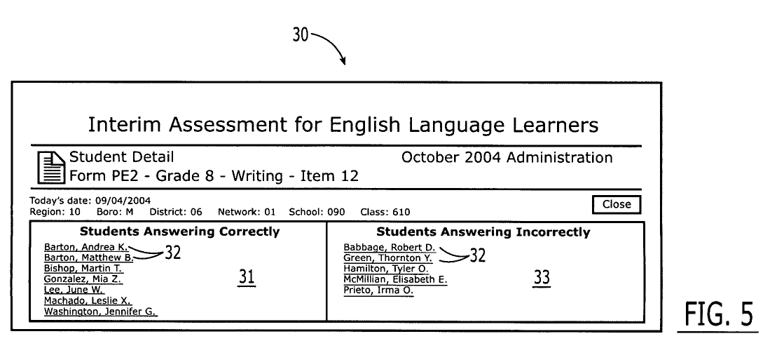

The item values 25 also comprise electronic links to a student detail report 30 (FIG. 5), which includes a first list 31 of student identifiers 32 representative of students who answered the item correctly and a second list 33 of student identifiers 32 representative of students who answered the item incorrectly (block 105). This report can provide assistance to the teacher for instructional planning, by easily identifying those students, by item, who require more support in particular content areas.

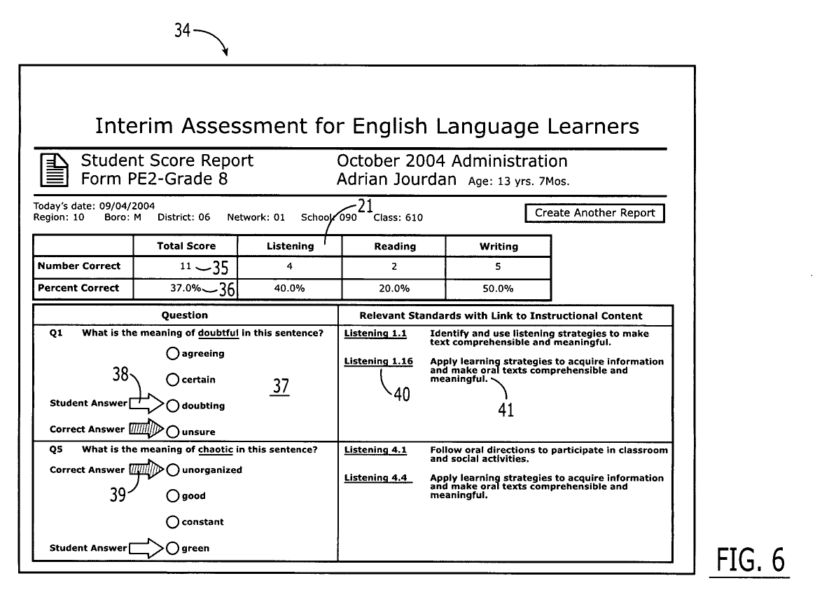

The student identifiers 32 also comprise electronic links to individual student score reports 34 (FIG. 6; block 106), which summarize the individual student's assessment results, including, for the total assessment and for each skill grouping 21, a number 35 and a percent 36 correct. The student score report 34 also displays a reproduction 37 of each incorrectly answered item, along with a first indicator 38, for example, in red, of the student's answer, and a second indicator 39, for example, in green, of the correct answer (block 107).

Correlated with each item 37 is a column containing the content standard(s) associated therewith, including the number 40 and a definition 41 of each standard. The standard number 40 also comprises an electronic link to the relevant instructional content (block 108).

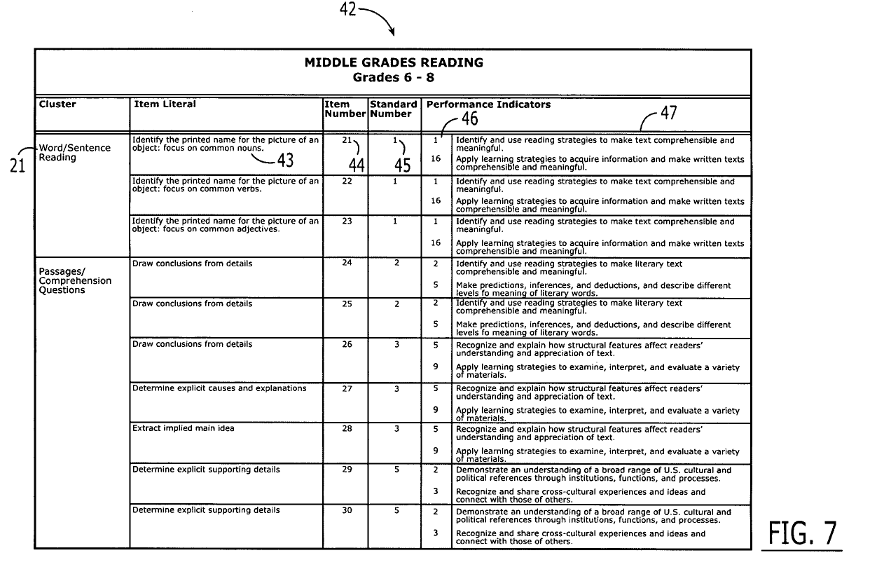

Also accessible from the summary ranking report 18 of FIG. 4 is table 42 of standards and performance indicators (FIG. 7). In this display are given, for each skill grouping 21, the item stem 43, item number 44, standard number 45, performance indicator number 46, and performance indicator verbiage 47 (block 109).

The summary ranking report 18 also links to a plurality of standard and performance indicators 45-47 linked to respective remedial instruction 48 contained in a second database sector 49. Two exemplary displays are illustrated in FIGS. 8 and 9, wherein the final column lists retrieved lessons and activities for achieving a remediation of material on which an item was answered incorrectly (block 110).

It can thus be seen that correlations of item and standards data for individual students and for entire classes can be used to create remedial learning action plans and teaching action plans based upon retrieved data.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the method and system illustrated and described herein are by way of example, and the scope of the invention is not limited to the exact details of construction.

Having now described the invention, the construction, the operation and use of preferred embodiments thereof, and the advantageous new and useful results obtained thereby, the new and useful constructions, and reasonable equivalents thereof obvious to those skilled in the art, are set forth in the appended claims.

What is claimed is:

1. A method for automatically producing a remedial action plan for a plurality of students and for a teacher of the plurality of students based upon assessment results for at least some of the students, the method comprising the steps of:
receiving score results from answer documents completed by a plurality of students in a unitary class for an assessment comprising a plurality of items representative of a plurality of content standards, each item designed to assess at least one content standard, each item having been scored incorrect or correct;
electronically correlating each incorrect answer for each student with the respective content standard;
retrieving from a database a remedial learning action for each correlated content standard;
automatically producing a remedial learning action plan from the retrieved remedial learning actions;
electronically correlating incorrect answers for the plurality of students with respective content standards;
calculating a proportion of the plurality of students needing remediation in each of the respective content standards;
retrieving from the database a remedial teaching action for each of the content standards for which the calculated proportion exceeds a predetermined value; and
automatically producing a remedial teaching action plan from the retrieved remedial teaching actions.

2. The method recited in claim 1, further comprising the step of, for each item, creating and displaying a list of student identifiers representative of students who answered the item incorrectly.

3. The method recited in claim 2, further comprising the step of creating an electronic student report for each student summarizing respective student assessment results and including for each incorrectly answered item for the respective student a reproduction of the item and the content standard associated therewith, the electronic student report accessible via an electronic link on the student identifier list.

4. The method recited in claim 3, wherein instructional content for each of the associated content standards is accessible from the student report via an electronic linkage to a record in a database.

5. The method recited in claim 3, wherein the item reproduction includes an indicator of a correct answer to the item and the incorrect answer given by the student.

6. The method recited in claim 2, further comprising the step of, for each item, creating and displaying a list of student identifiers representative of students who answered the item correctly.

7. The method recited in claim 1, further comprising the step of creating a summary report, the summary report including:
a list of the items separated into skill groupings, each skill grouping having associated therewith at least one content standard;
indicia for each item representative of a proportion of the plurality of students who answered the respective item correctly; and
indicia for each skill grouping representative of an average proportion of the plurality of students who answered the items within the respective skill grouping correctly.

8. The method recited in claim 7, wherein the summary report further includes an electronic link to information on the content standard associated with each skill grouping.

9. The method recited in claim 7, wherein the skill groupings listed in the summary report are listed in order of average correctly answered proportion.

10. A system for automatically producing a remedial action plan for a plurality of students and for a teacher of the plurality of students based upon assessment results for at least some of the students, the system comprising:
a first database sector containing score results from answer documents completed by a plurality of students in a unitary class for an assessment comprising a plurality of items representative of a plurality of content standards, each item designed to assess at least one content standard, each item having been scored incorrect or correct;
a second database sector containing a remedial instructional action for each content standard assessed; and
an electronic medium having stored thereon a software package comprising computer code segments adapted to:
retrieve from the first database sector incorrect answers for each student;
electronically correlate incorrect answers for each student with respective content standards;
retrieve from the second database sector a remedial instructional action for each correlated content standard;
automatically produce a remedial learning action plan from the retrieved remedial instructional actions;
electronically correlate incorrect answers for the plurality of students with respective content standards;
calculate a proportion of the plurality of students needing remediation in each of the respective content standards;
retrieve from the second database sector a remedial instructional action for each of the content standards for which the calculated proportion exceeds a predetermined value; and
produce a remedial teaching action plan from the retrieved remedial instructional actions.

11. The system recited in claim 10, wherein the software package further comprises computer code segments adapted to, for each item, create and display a list of student identifiers representative of students who answered the item incorrectly.

12. The system recited in claim 11, wherein the software package further comprises computer code segments adapted to create an electronic student report for each student summarizing respective student assessment results and including for each incorrectly answered item for the respective student a reproduction of the item and the content standard associated therewith, and to provide an electronic link to the electronic student report from the student identifier list.

13. The system recited in claim 12, wherein the software package further comprises a computer code segment adapted to provide an electronic link to instructional content for each of the associated content standards from the student report.

14. The system recited in claim 12, wherein the item reproduction includes an indicator of a correct answer to the item and the incorrect answer given by the student.

15. The system recited in claim 11, wherein the software package further comprises a computer code segment adapted to, for each item, create and display a list of student identifiers representative of students who answered the item correctly.

16. The system recited in claim 10, wherein the software package further comprises computer code segments adapted to create a summary report, the summary report including:
a list of the items separated into skill groupings, each skill grouping having associated therewith at least one content standard;
indicia for each item representative of a proportion of the plurality of students who answered the respective item correctly; and
indicia for each skill grouping representative of an average proportion of the plurality of students who answered the items within the respective skill grouping correctly.

17. The system recited in claim 16, wherein the software package further comprises computer code segments adapted to establish in the summary report an electronic link to information on the content standard associated with each skill grouping.

18. The system recited in claim 16, wherein the skill groupings listed in the summary report are listed in order of average correctly answered proportion.
